(19) United States
(12) Patent Application Publication
(10) Pub. No.: US 2011/0179082 A1
(43) Pub. Date: Jul. 21, 2011

(54) MANAGING CONCURRENT FILE SYSTEM ACCESSES BY MULTIPLE SERVERS USING LOCKS

(75) Inventors: Satyam B. VAGHANI, San Jose, CA (US); Manjunath RAJASHEKHAR, San Francisco, CA (US)

(73) Assignee: VMWARE, INC., Palo Alto, CA (US)

(21) Appl. No.: 13/074,916

(22) Filed: Mar. 29, 2011

Related U.S. Application Data
(63) Continuation-in-part of application No. 12/939,532, filed on Nov. 4, 2010.
Application No. 12/939,532 is a continuation of application No. 10/773,613, filed on Feb. 6, 2004, now Pat. No. 7,849,098.
Application No. 10/773,613 is a continuation-in-part of application No. 11/676,109, filed on Feb. 16, 2007.

(51) Int. Cl. G06F 17/30

(52) U.S. Cl. 707/781; 707/E17.007

(57) ABSTRACT

Atomic test and set (ATS) operations are carried out to perform lock operations that allow a node to acquire or release a lock to a resource of a shared file system that is stored in a data storage unit (DSU) and update its liveness information. Each ATS operation includes the step of comparing contents accessed and read through the shared file system and contents stored at a particular logical block number of the DSU. If the two contents match, updates to the contents of the lock or the liveness information are permitted.

### CROSS-REFERENCE TO RELATED APPLICATION(S)

This application is a continuation-in-part of U.S. patent application Ser. No. 12/939,532 filed Nov. 4, 2010, which is a continuation of U.S. Pat. No. 7,849,098 issued Dec. 7, 2010, and U.S. patent application Ser. No. 11/676,109 filed Feb. 16, 2007, both of which are incorporated by reference herein.

### BACKGROUND

As computer systems scale to enterprise levels, particularly in the context of supporting large-scale data centers, the underlying data storage systems frequently adopt the use of storage area networks (SANs). As is conventionally well appreciated, SANs provide a number of technical capabilities and operational benefits, fundamentally including virtualization of data storage devices, redundancy of physical devices with transparent fault-tolerant fail-over and fail-safe controls, geographically distributed and replicated storage, and centralized oversight and storage configuration management decoupled from client-centric computer systems management.

Architecturally, a SAN storage subsystem is characteristically implemented as a large array of Small Computer System Interface (SCSI) protocol-based storage devices. One or more physical SCSI controllers operate as externally-accessible targets for data storage commands and data transfer operations. The target controllers internally support bus connections to the data storage devices, identified as logical unit numbers (LUNs). The storage array is collectively managed internally by a storage system manager to virtualize the physical data storage devices. The storage system manager is thus able to aggregate the physical devices present in the storage array into one or more logical storage containers. Virtualized segments of these containers can then be allocated by the storage system as externally visible and accessible LUNs with unique identifiers. A SAN storage subsystem thus presents the appearance of simply constituting a set of SCSI targets hosting respective sets of LUNs. While specific storage system manager implementation details differ between different SAN storage device manufacturers, the desired consistent result is that the externally visible SAN targets and LUNs fully implement the expected SCSI semantics necessary to respond to and complete initiated transactions against the managed container.

A SAN storage subsystem is typically accessed by a server computer system implementing a physical host bus adapter (HBA) that connects to the SAN through network connections. Within the server and above the host bus adapter, storage access abstractions are characteristically implemented through a series of software layers, beginning with a low-level SCSI driver layer and ending in an operating system specific file system layer. The driver layer, which enables basic access to the target ports and LUNs, is typically vendor-specific to the implementation of the SAN storage subsystem. A data access layer may be implemented above the device driver to support multipath consolidation of the LUNs visible through the host bus adapter and other data access control and management functions. A logical volume manager (LVM), typically implemented between the driver and conventional operating system file system layers, supports volume-oriented virtualization and management of the LUNs that are accessible through the host bus adapter. Multiple LUNs can be gathered and managed together as a volume under the control of the logical volume manager for presentation to and use by the file system layer as an integral LUN.

In typical implementations, a SAN storage subsystem connects with upper-tiers of client and server computer systems through a communications matrix that is frequently implemented using the Fibre Channel Protocol (FCP) or Internet Small Computer System Interface (iSCSI) standard. When multiple upper-tiers of client and server computer systems (referred to herein as “nodes”) access the SAN storage subsystem, two or more nodes may also access the same system resource within the SAN storage subsystem. In such a scenario, a locking mechanism is needed to synchronize the input/output (IO) operations of the multiple nodes within the computer system. More specifically, a lock is a mechanism utilized by a node in order to gain access to a system resource located on shared storage and to handle competing requests among multiple nodes in an orderly and efficient manner.

Using the SCSI protocol, a node may acquire, release or update a lock (referred to herein as a “lock operation”) associated with a system resource within a particular LUN. When performing any of the above-mentioned lock operations, a SCSI reservation primitive is propagated by the node to the LUN. The SCSI reservation primitive, when received by the LUN, provides the node with exclusive access to the entire LUN to perform the lock operation. During a SCSI reserve, no other node can perform any IO operation on the LUN to the system resource being locked or any other system resource. In other words, the act of host h1 acquiring a lock l1 via a reservation blocks out host h2 that wants to acquire a completely unrelated lock l2. Secondly, host h3 is blocked from reading and writing to a completely orthogonal resource r3 that is governed by a different lock l3 that is already in the acquired state. Therefore, because a SCSI reserve results in blocking all other access of nodes to the LUN, using this reservation mechanism to perform lock operations is inefficient and causes performance bottlenecks.

As the foregoing illustrates, what is needed in the art is a mechanism for performing lock operations to data structures on a LUN without blocking IO access to the entire LUN from other hosts connected to said LUN.

### SUMMARY

One or more embodiments of the present invention provide atomic test and set (ATS) operations used in performing lock operations that allow a node to acquire or release a lock to a resource of a shared file system that is stored in a data storage unit (DSU) without requiring a SCSI reservation of the DSU that prevents other nodes from performing IO with the DSU. A method of managing accesses to a resource of a shared file system that is stored in a DSU, according to an embodiment of the present invention, includes the steps of reading a lock associated with the resource to obtain a current state of the lock, determining that the lock is available based on the current state, transmitting a request to the DSU to perform an atomic update to the lock comprising a first operation to confirm that the current state of the lock has not changed since the reading and a second operation to acquire the lock, wherein no other operation can be performed on the lock between the first operation and second operation, and acquiring access to the resource upon receiving confirmation of successful completion of the atomic update, whereby no exclusive reservation of the DSU is required to acquire the lock.

### BRIEF DESCRIPTION OF THE DRAWINGS

FIG. 1 illustrates a computer system configuration utilizing a shared file system in which one or more embodiments of the present invention may be implemented.

FIG. 2 illustrates a virtual machine based computer system, according to an embodiment.

FIG. 3 illustrates data fields of a lock used in one or more embodiments of the present invention.

FIG. 4 illustrates a logical organization and relationship between a plurality of nodes, locks, data entities and heartbeats, as implemented in one or more embodiment of the present invention.

FIG. 5 illustrates a more detailed view of the heartbeat region of FIG. 4 and the lock of FIG. 3.

FIG. 6 is a state diagram that illustrates the three possible states to which a resource that has an associated lock can transition.

FIG. 7 is a flow diagram of method steps for acquiring a lock associated with a resource using an ATS primitive, according to one or more embodiments of the present invention.

FIG. 8 is a flow diagram of method steps for releasing a lock acquired by a specific node, according to one or more embodiments of the present invention.

FIG. 9 is a flow diagram of method steps for updating the heartbeat of a node, according to one or more embodiments of the present invention.

### DETAILED DESCRIPTION

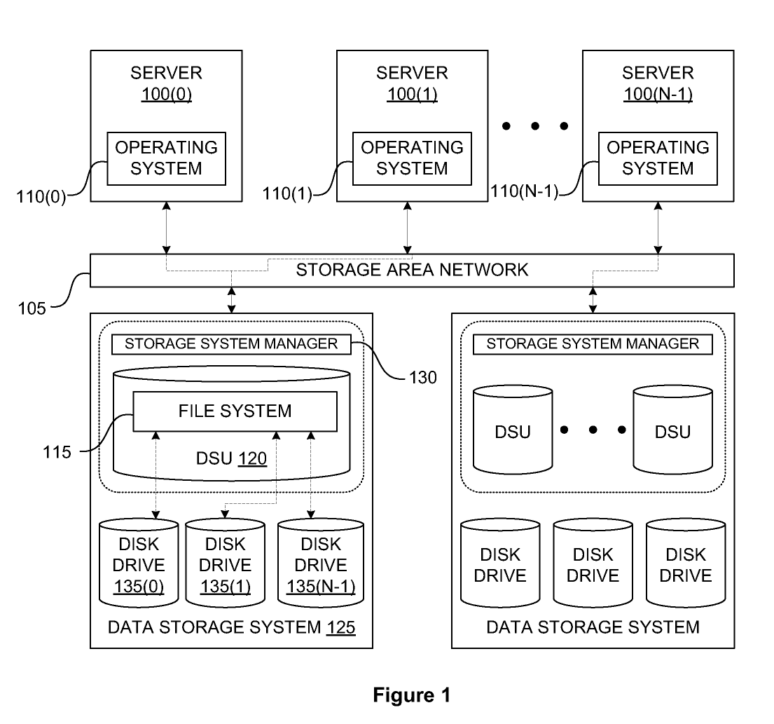

FIG. 1 illustrates a computer system configuration utilizing a shared file system, also known as a clustered file system, in which one or more embodiments of the present invention may be implemented. The computer system configuration of FIG. 1 includes multiple servers 100(0) to 100(N−1), each of which is connected to storage area network (SAN) 105. Operating systems 110(0) and 110(1) on servers 100(0) and 100(1) interact via a shared file system 115 with data that resides on a data storage unit (DSU) 120 accessible through SAN 105. In particular, DSU 120 is a logical unit (LUN) of a data storage system 125 (e.g., disk array) connected to SAN 105. While DSU 120 is exposed to operating systems 110(0) and 110(1) by storage system manager 130 (e.g., disk controller) as a contiguous logical storage space, the actual physical data blocks upon which data access through shared file system 115 may be stored is dispersed across the various physical disk drives 135(0) to 135(N−1) of data storage system 125. The logical storage space of DSU 120 is organized as a series of logical data blocks, where each logical data block corresponds to an actual physical data block and is uniquely identified by a logical block number (LBN).

Data in DSU 120 (and possibly other DSUs exposed by the data storage systems) are accessed and stored in accordance with structures and conventions imposed by shared file system 115 which, for example, stores such data as a plurality of files of various types, typically organized into one or more directories. Shared file system 115 further includes metadata data structures that store or otherwise specify information, for example, about how data is stored within shared file system 115, such as block bitmaps that indicate which data blocks in shared file system 115 remain available for use, along with other metadata data structures indicating the directories and files in shared file system 115, along with their location. For example, sometimes referred to as a file descriptor or inode, each file and directory may have its own metadata data structure associated therewith, specifying various information, such as the data blocks that constitute the file or directory, the date of creation of the file or directory, etc.

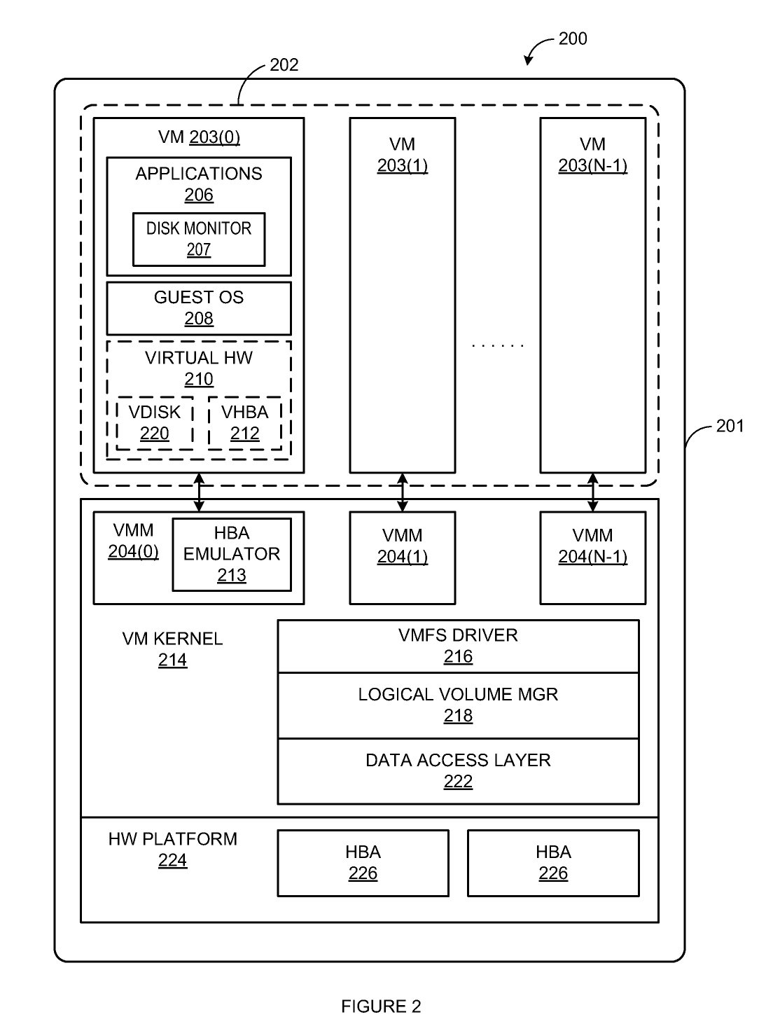

FIG. 2 illustrates a virtual machine based system 200 in which one or more embodiments of the present invention may be implemented. An computer system 201, generally corresponding to one of the computer system servers 110, is constructed on a conventional, typically server-class hardware platform 224, including in particular host bus adapters (HBAs) 226 in addition to conventional platform processor, memory, and other standard peripheral components (not separately shown). Hardware platform 224 executes a virtual machine operating system kernel 214 (also referred to as a hypervisor or as virtualization software) supporting a virtual machine execution space 202 within which virtual machines (VMs) 203 are executed. In one or more embodiments of the present invention, the virtual machine operating system kernel 214 and virtual machines 203 are implemented using the vSphere product (and related utilizes) developed and distributed by VMware, Inc. of Palo Alto, Calif., although it should be recognized that vSphere is not required in the practice of the teachings herein.

Virtual machine operating system kernel 214 provides the services and support that enable concurrent execution of the virtual machines 203. Each virtual machine 203 supports the execution of a guest operating system 208, which, in turn, supports the execution of applications 206. Examples of guest operating systems 208 include Microsoft Windows, the Linux, and Netware-based operating systems, although it should be recognized that any other operating system may be used in embodiments. Guest operating system 208 includes a native file system layer, such as, for example, an NTFS or ext3FS type file system. The guest file system may utilize a host bus adapter driver (not shown) in guest operating system 208 to interact with a host bus adapter emulator 213 in a virtual machine monitor (VMM) component 204 of hypervisor 214. Conceptually, this interaction provides guest operating system 208 (and the guest file system) with the perception that it is interacting with actual hardware.

FIG. 2 illustrates a virtual machine based computer system 200, according to an embodiment. A computer system 201, generally corresponding to one of the servers 100, is constructed on a conventional, typically server-class hardware platform 224, including, for example, host bus adapters (HBAs) 226 that network computer system 201 to remote data storage systems, in addition to conventional platform processor, memory, and other standard peripheral components (not separately shown). Hardware platform 224 is used to execute a hypervisor 214 (also referred to as virtualization software) supporting a virtual machine execution space 202 within which virtual machines (VMs) 203 can be instantiated and executed. For example, in one embodiment, hypervisor 214 may correspond to the vSphere product (and related utilities) developed and distributed by VMware, Inc., Palo Alto, Calif. although it should be recognized that vSphere is not required in the practice of the teachings herein.

Hypervisor 214 provides the services and support that enable concurrent execution of virtual machines 203. Each virtual machine 203 supports the execution of a guest operating system 208, which, in turn, supports the execution of applications 206. Examples of guest operating system 208 include Microsoft® Windows®, the Linux® operating system, and NetWare®-based operating systems, although it should be recognized that any other operating system may be used in embodiments. Guest operating system 208 includes a native or guest file system, such as, for example, an NTFS or ext3FS type file system. The guest file system may utilize a host bus adapter driver (not shown) in guest operating system 208 to interact with a host bus adapter emulator 213 in a virtual machine monitor (VMM) component 204 of hypervisor 214. Conceptually, this interaction provides guest operating system 208 (and the guest file system) with the perception that it is interacting with actual hardware.

FIG. 2 also depicts a virtual hardware platform 210 as a conceptual layer in virtual machine 203(0) that includes virtual devices, such as virtual host bus adapter (HBA) 212 and virtual disk 220, which itself may be accessed by guest operating system 208 through virtual HBA 212. In one embodiment, the perception of a virtual machine that includes such virtual devices is effectuated through the interaction of device driver components in guest operating system 208 with device emulation components (such as host bus adapter emulator 213) in VMM 204(0) (and other components in hypervisor 214).

File system calls initiated by guest operating system 208 to perform file system-related data transfer and control operations are processed and passed to virtual machine monitor (VMM) components 204 and other components of hypervisor 214 that implement the virtual system support necessary to coordinate operation with hardware platform 224. For example, HBA emulator 213 functionally enables data transfer and control operations to be ultimately passed to the host bus adapters 226. File system calls for performing data transfer and control operations generated, for example, by one of applications 206 are translated and passed to a virtual machine file system (VMFS) driver 216 that manages access to files (e.g., virtual disks, etc.) stored in data storage systems (such as data storage system 125) that may be accessed by any of the virtual machines 203. In one embodiment, access to DSU 120 is managed by VMFS driver 216 and shared file system 115 for LUN 120 is a virtual machine file system (VMFS) that imposes an organization of the files and directories stored in DSU 120, in a manner understood by VMFS driver 216. For example, guest operating system 208 receives file system calls and performs corresponding command and data transfer operations against virtual disks, such as virtual SCSI devices accessible through HBA emulator 213, that are visible to guest operating system 208. Each such virtual disk may be maintained as a file or set of files stored on VMFS, for example, in DSU 120. The file or set of files may be generally referred to herein as a virtual disk and, in one embodiment, complies with virtual machine disk format specifications promulgated by VMware (e.g., sometimes referred to as a vmdk files). File system calls received by guest operating system 208 are translated to instructions applicable to particular file in a virtual disk visible to guest operating system 208 (e.g., data block-level instructions for 4 KB data blocks of the virtual disk, etc.) to instructions applicable to a corresponding vmdk file in VMFS (e.g., virtual machine file system data block-level instructions for 1 MB data blocks of the virtual disk) and ultimately to instructions applicable to a DSU exposed by data storage unit 125 that stores the VMFS (e.g., SCSI data sector-level commands). Such translations are performed through a number of component layers of an “IO stack,” beginning at guest operating system 208 (which receives the file system calls from applications 206), through host bus emulator 213, VMFS driver 216, a logical volume manager 218 which assists VMFS driver 216 with mapping files stored in VMFS with the DSUs exposed by data storage systems networked through SAN 105, a data access layer 222, including device drivers, and host bus adapters 226 (which, e.g., issues SCSI commands to data storage system 125 to access LUN 120).

In one embodiment, guest operating system 208 further supports the execution of a disk monitor application 207 that monitors the use of data blocks of the guest file system (e.g., by tracking relevant bitmaps and other metadata data structures used by guest file system, etc.) and issues unmap commands (through guest operating system 208) to free data blocks in the virtual disk. The unmap commands may be issued by disk monitor application 207 according to one of several techniques. According to one technique, disk monitor application 207 creates a set of temporary files and causes guest operating system 208 to allocate data blocks for all of these files. Then, disk monitor application 207 calls into the guest operating system 208 to get the locations of the allocated data blocks, issues unmap commands on these locations, and then deletes the temporary files. According to another technique, the file system driver within the guest operating system 208 is modified to issues unmap commands as part of a file system delete operation. Other techniques may be employed if the file system data structures and contents of the data blocks are known. For example, in embodiments where virtual disk 220 is a SCSI-compliant device, disk monitor application 207 may interact with guest operating system 208 to request issuance of SCSI UNMAP commands to virtual disk 220 (e.g., via virtual HBA 212) in order to free certain data blocks that are no longer used by guest file system (e.g., blocks relating to deleted files, etc.). References to data blocks in instructions issued or transmitted by guest operating system 208 to virtual disk 220 are sometimes referred to herein as “logical” data blocks since virtual disk 220 is itself a logical conception (as opposed to physical) that is implemented as a file stored in a remote storage system. It should be recognized that there are various methods to enable disk monitor application 207 to monitor and free logical data blocks of guest file system. For example, in one embodiment, disk monitor application 207 may periodically scan and track relevant bitmaps and other metadata data structures used by guest file system to determine which logical data blocks have been freed and accordingly transmit unmap commands based upon such scanning. In an alternative embodiment, disk monitor application 207 may detect and intercept (e.g., via a file system filter driver or other similar methods) disk operations transmitted by applications 206 or guest operating system 208 to an HBA driver in guest operating system 208 and assess whether such disk operations should trigger disk monitor application 207 to transmit corresponding unmap commands to virtual disk 220 (e.g., file deletion operations, etc.) It should further be recognized that the functionality of disk monitor application 207 may be implemented in alternative embodiments in other levels of the IO stack. For example, while FIG. 2 depicts disk monitor application 207 as a user-level application (e.g., running in the background), alternative embodiments may implement such functionality within the guest operating system 208 (e.g., such as a device driver level component, etc.) or within the various layers of the IO stack of hypervisor 214. It should be recognized that the various terms, layers and categorizations used to describe the virtualization components in FIG. 2 may be referred to differently without departing from their functionality or the spirit or scope of the invention. For example, virtual machine monitors (VMM) 204 may be considered separate virtualization components between VMs 203 and hypervisor 214 (which, in such a conception, may itself be considered a virtualization “kernel” component) since there exists a separate VMM for each instantiated VM. Alternatively, each VMM may be considered to be a component of its corresponding virtual machine since such VMM includes the hardware emulation components for the virtual machine. In such an alternative conception, for example, the conceptual layer described as virtual hardware platform 210 may be merged with and into VMM 204 such that virtual host bus adapter 212 is removed from FIG. 2 (i.e., since its functionality is effectuated by host bus adapter emulator 213).

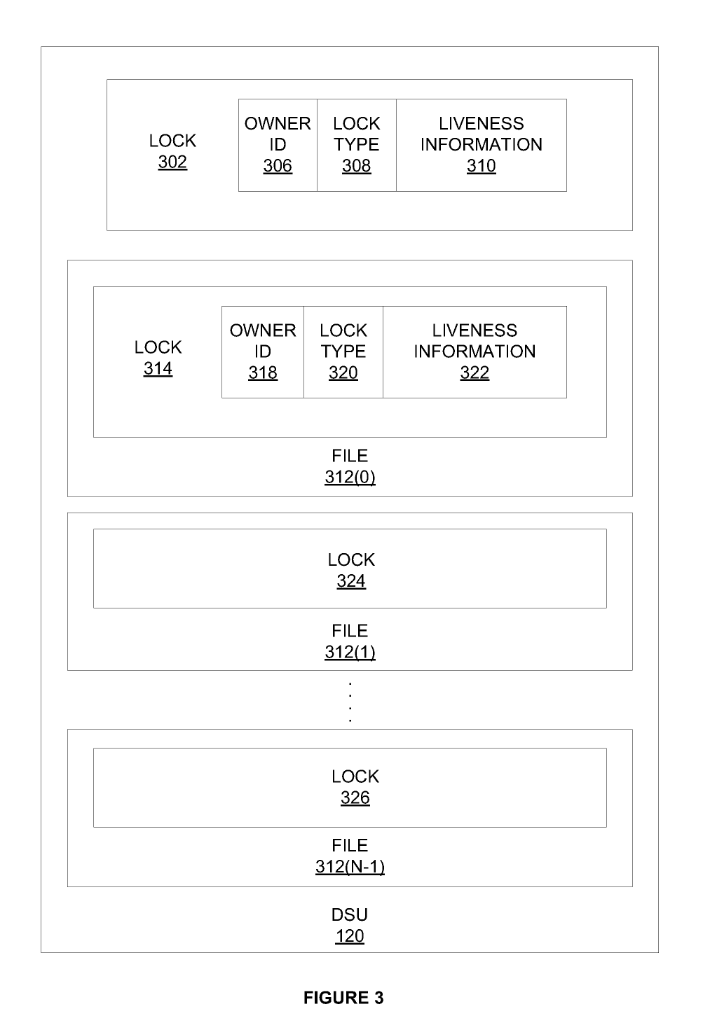

FIG. 3 illustrates data fields of a lock used in one or more embodiments of the present invention. FIG. 3 depicts a DSU 120 storing data organized in accordance with file system 115 (e.g., VMFS). As illustrated, a lock 302 corresponds to DSU 120 as a whole and has data fields for an owner identification (ID) 306, a lock type 308, and liveness information 310. A file stored in DSU 120 in accordance with file system 115 (VMFS) is another example of a resource that has an associated lock 314. In FIG. 3, file 312(0) is associated with lock 314, file 312(1) with lock 324, and file 312(N−1) with lock 326. For example, each such file 312 may be a vmdk file that represents a virtual disk for one of VMs 203. Other resources that have locks include a directory of files, a file block allocation bitmap, or the file system header itself. Thus, to change the configuration data of file system 115, such as by allocating a new data block to a file or a directory, a server must first obtain the lock associated with the file block allocation bitmap of file system 115. Similarly, to change the configuration data of a directory within file system 115, such as by adding a new sub-directory, a server must first obtain the lock associated with the directory.

The location of the lock 302 within DSU 120 is uniquely identified by a particular LBN. Owner ID 306 may be a unit of data, such as a 16-byte unique identifier, a word, etc., that is used to identify the server that owns or possesses lock 302. Possessing a lock such as 302 or 314 gives the server exclusive access to the resource, e.g., a file, a directory of files, or the DSU itself, associated with the lock. Owner ID 306 may contain a zero or some other special value to indicate that no server currently owns the lock, or it may contain an identification (ID) value of one of the servers to indicate that the respective server currently owns the lock. For example, each of servers 100 may be assigned a unique ID value, which could be inserted into the data field for owner ID 306 to indicate that the respective server owns lock 302. A unique ID value need not be assigned manually by a system administrator, or in some other centralized manner. Instead, the ID values may be determined for each of the servers 100 in an automated manner, for example, by using the server's IP address or the MAC (Media Access Control) address of the server's network interface card, by using the World Wide Name (WWN) of the server's first HBA, or by using a Universally Unique Identifier (UUID). For the rest of this description, it will be assumed that a zero is used to indicate that a lock is not currently owned, although other values may also be used for this purpose. The data field for lock type 308 indicates the type of lock and may be implemented with any enumeration data type that is capable of assuming multiple states. Typical types of locks may include any of a Null, Concurrent read and write, Concurrent read only, Single writer concurrent readers, or Exclusive read and write lock type.

Lock 302 is owned or possessed by a server on a renewable-lease basis. When a server obtains lock 302, it owns the lock for a specified period of time. The server may extend the period of ownership, or the lease period, by renewing the lease. Once the lease period ends, another server may take possession of the lock. In one embodiment, each lease lasts only for a predetermined period of time.

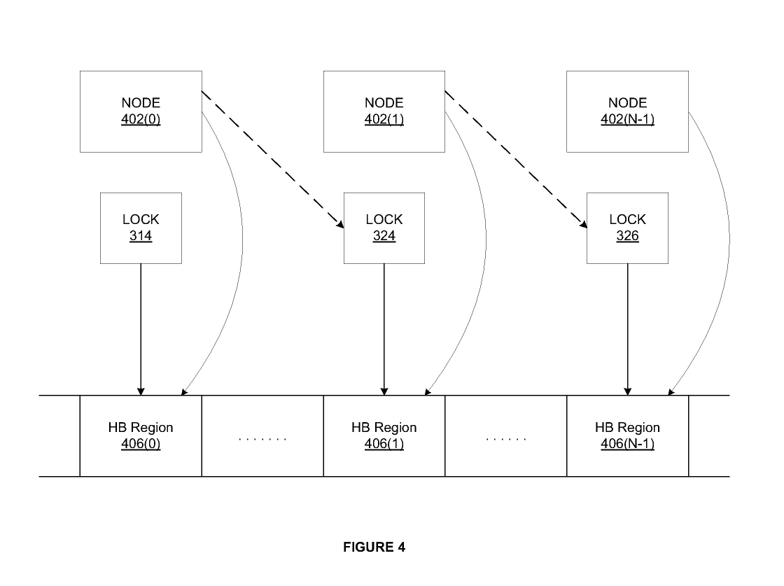

The data field of liveness information 310 stores heartbeat location, which is described below in conjunction with FIGS. 4-6. FIG. 4 illustrates a logical organization and relationship between a plurality of nodes, locks, data entities and heartbeats, as implemented in one or more embodiment of the present invention. As used herein, a “node” is any entity, such as a server 100, that shares the same resources with other nodes. As illustrated in FIG. 4, each of the nodes 402 is uniquely associated with a specific heartbeat region 406 in the file system 115. Node 402(0) holds lock 314 associated with file 312(0). Lock 314 has associated therewith pointer data in liveness information 322 which identifies heartbeat region 406(0) as uniquely associated with node 402(0). Similarly, lock 324 held by node 402(1) has associated therewith pointer data which identifies heartbeat region 406(1) as uniquely associated with node 402(1). By requiring all nodes to periodically refresh their respective heartbeat regions 406 with either a monotonically increasing number or a random number, a protocol which enables other nodes to determine whether a node's heartbeat and locks are viable or stale is possible. For example, in FIG. 4, the solid curved lines from each of the nodes 402(0) and 402(1) to their respective heartbeat regions 406 indicates refreshing of their respective heartbeat regions 406.

Node 402(N−1) represents a node that is no longer refreshing its heartbeat region 406(N−1). Lock 326, which is held by node 402(N−1), still points to heartbeat region 406(N−1) associated with node 402(N−1). Because node 402(N−1) is no longer refreshing heartbeat region 406(N−1), it would be possible for another node (e.g., node 402(1)) to acquire lock 326 by examining the heartbeat region 406(N−1) referenced by lock 326 and determining that the current holder of the lock has not refreshed its heartbeat and is thus stale. Conversely, a lock that points to heartbeat region 406 that is being periodically refreshed cannot be acquired by another node. For example, lock 324 cannot be acquired by node 402(0) because the heartbeat region 406(1) to which lock 324 points is being refreshed.

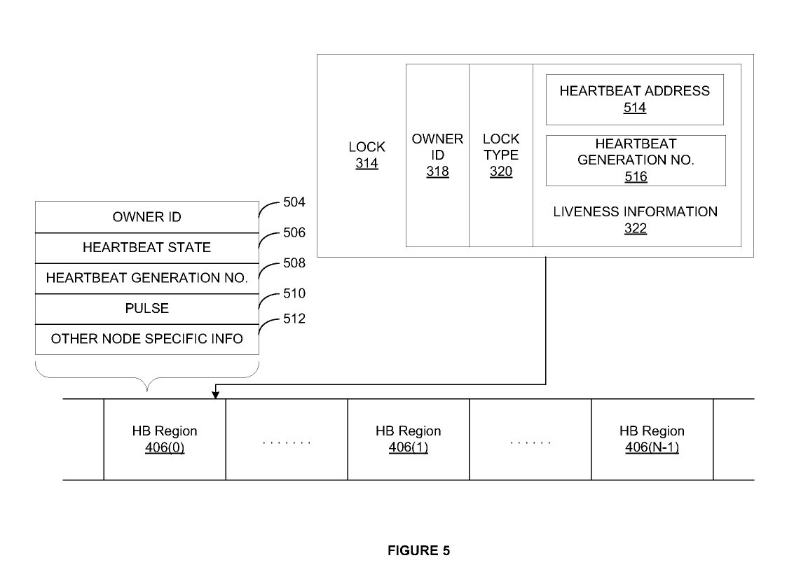

FIG. 5 illustrates a more detailed view of the heartbeat region of FIG. 4 and the lock of FIG. 3. As shown, the heartbeat region has data fields for a logical block number 502, an owner ID 504, a heartbeat state 506, a heartbeat generation number 508, a pulse field 510, and other node specific information 512. Logical block number 502 uniquely identifies the location of the heartbeat region within DSU 120. Owner ID 504 uniquely identifies the node associated with the heartbeat region and may be implemented with any data type, including, but not limited to, alphanumeric or binary, with a length chosen that allows for a sufficient number of unique identifiers. In an alternative embodiment, the data field for owner ID 504 can be omitted since it is possible to uniquely identify a node using only the address of the heartbeat region and the heartbeat generation number.

Heartbeat state 506 indicates the current state of the heartbeat and may be implemented with any enumeration data type that is capable of assuming multiple states. In the illustrative embodiment, the heartbeat state value may assume any of the following states:

CLEAR—heartbeat is not currently being used;

IN_USE—heartbeat structure is being used by a node; and

BREAKING—heartbeat has timed out and is being cleared by another node.

Heartbeat generation number 508 is a modifiable value and is typically incremented each time the heartbeat region is allocated to a node. Heartbeat generation number 508 together with the address of the heartbeat region may be used to uniquely identify an instance of a node associated with the heartbeat region. For example, heartbeat generation number 508 may be used to determine if the same node has deallocated a heartbeat region and then reallocated the same region. Accordingly, the heartbeat generation number enables other nodes to determine if the heartbeat region is indicating a heartbeat by the same instance of a node as recorded in the lock data structure.

Pulse 510 is a value that changes each time the heartbeat is renewed and signifies heartbeating by its respective owner and may be implemented with a 64-bit integer data type. In one embodiment, pulse 510 may be implemented with a time stamp. Alternatively, pulse 510 may be implemented with another value that is not in a time format but changes each time the heartbeat is renewed, such as a counter.

The data field for other node-specific information area 512 is an undefined area that allows additional useful data to be stored along with heartbeat specific data and may include data that is unique to or associated with the node that currently owns the heartbeat. For example, in the context of a shared file system, a pointer to a journal file for the subject node that can be replayed if the node crashes may be stored within the data field for other node-specific information 512.

As also shown in FIG. 5, a lock includes data fields for owner ID 318, lock type 320, as previously described above. The data field for liveness information 322 stores a heartbeat address 514 that identifies the location of the heartbeat region associated with the lock owner and corresponds to the LBN of the heartbeat region, and a heartbeat generation number 516 that corresponds to heartbeat generation number 508 of the heartbeat region when the lock owner was allocated to the heartbeat region. It should be recognized that heartbeat generation number 508 and heartbeat generation number 516 may have the same value if the lock owner is continuously generating heartbeats. In this manner, another node can verify if the lock owner is still heartbeating and has not crashed since acquiring the lock. Typically, locks are stored within the same failure domain, such as the same DSU, as heartbeat region 406.

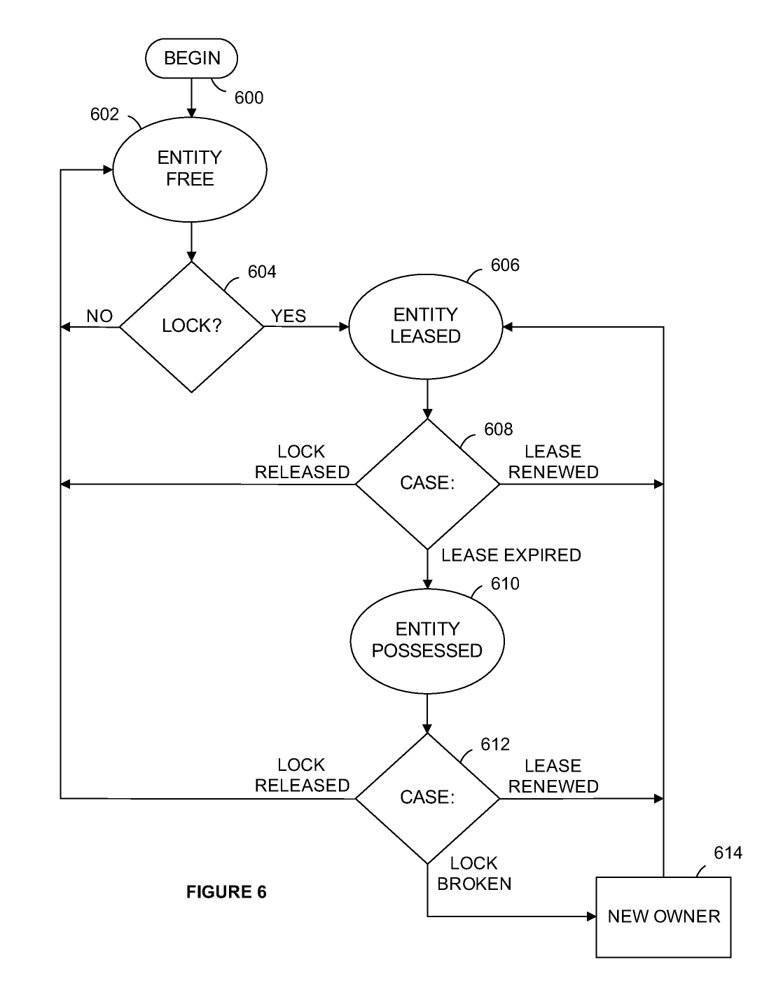

FIG. 6 is a state diagram that illustrates the three possible states to which a resource that has an associated lock can transition. In describing the state diagram of FIG. 6, reference is made to file 312(0) of FIG. 3, including lock 314, owner ID 318, and liveness information 322. The state diagram of FIG. 6 begins at 600. The initial state is a first state 602. When the resource, e.g., file 312(0), is in the first state 602, this means that it is not locked and in use by any server. Thus, the data field for owner ID 318 has a zero.

When a resource is in the free state 602, its lock can be acquired by a server, i.e., the resource can be locked by a server. The determination of whether or not locking has occurred is made at decision block 604. If locking by a server has occurred, the server writes its owner ID into the data field for owner ID 318 and updates the data field for lock type 320 and the data field for liveness information 322, and the resource transitions to a leased state 606. While the resource is in the leased state 606, the server is entitled to use the resource. If locking by a server has not occurred, the resource remains in the free state 602. From the leased state 606, the state diagram proceeds to a decision block 608. At this decision block, the server may release the lock to the resource, enabling another server to obtain the lock, or it may renew the lease (e.g., by updating the data field for pulse 510 in the heartbeat region 406) to ensure that it may continue to use the resource.

If, at decision block 608, the lock is not released and the lease is not renewed before the lease period runs out, then the lease expires. In this case, the resource transitions to a possessed state 610. Here, the data field for owner ID 318 still contains the ID value of the server that last leased the resource. At this point, the ownership of the resource is now vulnerable to being taken over by another server.

From the possessed state 610, the state diagram proceeds to a decision block 612. At this decision block, the server that currently possesses the lock to the resource may still release the lock or it may still renew the previous lease on the lock. If the lock is released, the state of the resource returns to the free state 602; whereas, if the lease is renewed, the state of the resource returns to the leased state 606. In addition, while the resource is in the possessed state 610, another server may break the lock to the resource and gain control of the resource by writing its own ID value into the data field for owner ID 318 and its own liveness information in the data field for liveness information 322. After another server has obtained ownership of the lock to the resource, as indicated by block 614, by writing its own ID value into the data field for owner ID 318 and updating the data field for liveness information 322, the state of the resource returns to the leased state 606.

Locks, such as lock 302 and lock 314, can be acquired, released or updated, via an “atomic test and set” (ATS) primitive that is, for example, transmitted by a host to a data storage system and executed atomically by the data storage system on a desired resource. During execution of such an ATS primitive, a “test” operation and a subsequent “set” operation are atomically executed by the data storage system on a specified resource such that no intervening operations are permitted to be executed on the specified resource between the test and set operations. Performing an ATS primitive on a lock such as lock 302 or lock 314 enables a host to capture a lock on the desired resource without the use of SCSI reservations and, thus, without locking out other hosts from concurrent LUN access. When an ATS primitive is executed, the current contents of a logical block within a LUN are first compared against a previously retrieved image of the logical block to make certain that the contents have not been modified. If the contents have not been modified, then the contents of the logical block are replaced with a new image. The comparison and replacing operations of the ATS primitive are performed atomically, thus guaranteeing the integrity of the contents within the logical block at any given time. In one embodiment, the semantics of the ATS primitive are:

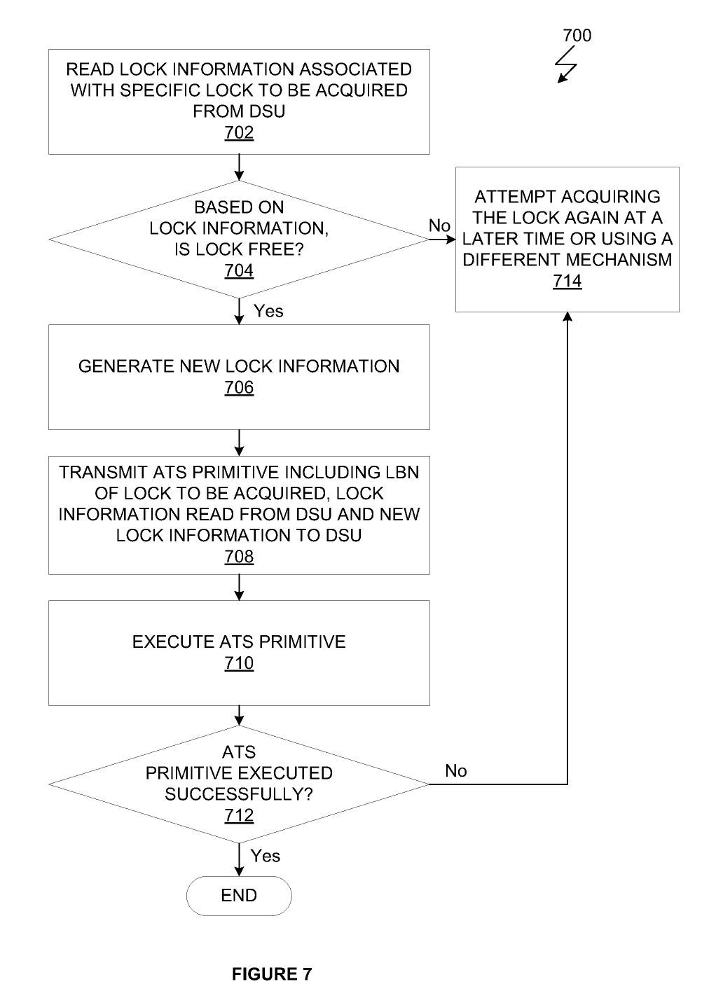

atomic_test_and_set(uint64 lbn, DiskBlock oldImage, DiskBlock newImage),

where lbn is the logical block number identifying the sector within the LUN to be modified, the oldImage is the initiator-provided disk image, and the newImage is the initiator provided disk image. In operation, once an ATS primitive is received, the data storage system atomically checks if the contents of the disk block at logical block number lbn are the same as oldImage. If so, then the oldImage is replaced with the newImage. In one embodiment, the ATS primitive is implemented via the COMPARE AND WRITE command operation code in the SCSI protocol for block devices. The use of ATS primitives to perform on-disk lock operations within the DSU 120, such as acquiring a lock, releasing a lock, and updating a lock, are described below in conjunction with FIGS. 7-9.

FIG. 7 is a flow diagram of method steps 700 for acquiring a lock associated with a resource using an atomic test and set (ATS) primitive, according to one or more embodiments of the present invention. For context and clarity and by way of example, method steps 700 are described herein using node 402(0) and lock 314 associated with file 312(0). It should be recognized that method steps 700 are applicable to other nodes operating on locks associated with other files or file systems within the DSU 120.

Method 700 begins at step 702, where node 402(0) reads lock information associated with lock 314 (referred to herein as the “old lock information”), which node 402(0) would like to acquire. At step 704, based on the old lock information, node 402(0) determines whether lock 314 is free. More specifically, such a determination is based on the value stored within the data field for owner ID 318 and the data field for liveness information 322 included in the old lock information. For example, if data field for owner ID 318 has a zero value or is empty, then lock 314 is free. Also, even if the data field for owner ID 318 does not hold a zero value or is not empty, lock 314 may be determined to be free if the lease to the lock has expired.

If, at step 704, lock 314 is free, then method 700 proceeds to step 706, where node 402(0) generates new lock information that specifies its owner ID value. The new lock information may also identify the heartbeat region 406(0) associated with node 402(0) as well as the current heartbeat generation number associated with node 402(0). In addition, the new lock information may include the lock type to be acquired. At step 708, node 402(0) transmits an ATS primitive that includes a logical block number identifying the location of lock 314 in DSU 120, the old lock information, and the new lock information generated at step 706 to DSU 120.

At step 710, storage system manager 130 executes the ATS primitive received from node 402(0). When an ATS primitive is executed, storage system manager 130 first locates lock 314 based on the logical block number included in the ATS primitive. Storage system manager 130 then compares the old lock information included in the ATS primitive with the lock information associated with lock 314 stored in DSU 120. If the old lock information and the lock information associated with lock 314 stored in DSU 120 match, then storage system manager 130 replaces the lock information stored in DSU 120 with the new lock information included in the ATS primitive. This results in a successful execution of the ATS primitive. However, if the old lock information and the lock information associated with the lock 314 stored in DSU 120 do not match, then the new lock information is not stored in the location of lock 314 in DSU 120 and the execution of the ATS primitive fails. In one embodiment, in the case of an ATS primitive execution failure, storage system manager 130 transmits an error code to node 402(0) indicating the execution failure.

At step 712, node 402(0) determines whether the ATS primitive executed successfully. If the ATS primitive executed successfully, then method 700 ends. If, however, the ATS primitive did not execute successfully, then method 700 proceeds to step 714. For example, the ATS primitive may not successfully execute, if after obtaining the old lock information in step 702, an intervening node successfully writes to the lock before the current node is able to transmit the ATS primitive at step 708. In such a situation, since the old lock information has changed due to the intervening node's write, the “test” operation of the ATS primitive will fail. At step 714, node 402(0) attempts to acquire lock 314 again at a later time or through a different technique known in the art. Referring back to step 704, if the lock information indicates that lock 314 is not free, then method 700 proceeds to 714, previously described above.

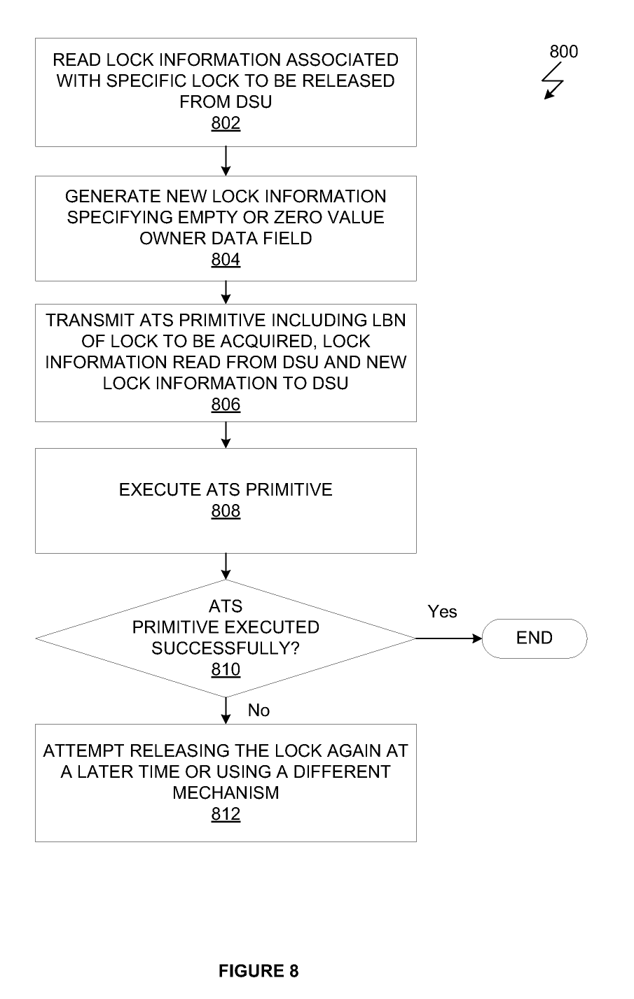

FIG. 8 is a flow diagram of method steps for releasing a lock acquired by a specific node, according to one or more embodiments of the present invention. As before, for context and clarity and by way of example, method steps 800 are described herein using node 402(0) and lock 314 associated with file 312(0). It should be recognized that method steps 800 are applicable to other nodes operating on locks associated with other files.

Method 800 begins at step 802, where node 402(0) reads lock information associated with lock 314 (referred to herein as the “old lock information”), which node 402(0) would like to release. At step 804, node 402(0) generates new lock information that specifies an empty or zero-value owner ID 318. As previously described herein, an empty or zero-value owner ID 318 indicates that the lock is free. At step 806, node 402(0) transmits an ATS primitive that includes a logical block number identifying the location of lock 314 in DSU 120, the old lock information, and the new lock information generated at step 804 to DSU 120.

At step 808, storage system manager 130 executes the ATS primitive received from node 402(0). When an ATS primitive is executed, storage system manager 130 first identifies lock 314 based on the logical block number included in the ATS primitive. Storage system manager 130 then compares the old lock information included in the ATS primitive with the lock information associated with the lock 314 stored in DSU 120. If the old lock information and the lock information associated with the lock 314 stored on DSU 120 match, then storage system manager 130 replaces the lock information stored in DSU 120 with the new lock information included in the ATS primitive. This results in the successful execution of the ATS primitive and consequently the writing of an empty or zero-value into the data field for owner ID 318 so that lock 314 is free to be acquired. However, if the old lock information and the lock information associated with lock 314 stored in DSU 120 do not match, then the new lock information is not stored in location of lock 314 in DSU 120 and the execution of the ATS primitive fails. For example, if the lease of lock 314 expired in the duration between when the old lock information was read and when the ATS primitive is executed, then another node may have already acquired the lock 314. In such a scenario, the old lock information and the lock information associated with lock 314 stored in DSU 120 do not match and the execution of the ATS primitive fails. In one embodiment, in the case of an ATS primitive execution failure, storage system manager 130 transmits an error code to node 402(0) indicating the execution failure.

At step 810, node 402(0) determines whether the ATS primitive executed successfully. If the ATS primitive executed successfully, then method 800 ends. If, however, the ATS primitive did not execute successfully, then method 800 proceeds to step 812. At step 812, node 402(0) attempts to release lock 314 again at a later time or through a different technique known in the art. This may include but is not limited to methods to make a determination as to whether the lock is still owned by node 402(0), or if it is in the possessed state 610, or if it has a new owner 614.

The ATS primitive may also be used to update the heartbeat associated with a node. During an ATS-based heartbeat update, a byzantine heartbeat write, where an entity that is not the owner of the heartbeat modifies the heartbeat, may be detected. More specifically, if, during the execution of the ATS-based heartbeat update, the content currently in the heartbeat region does not match the content previously read from the heartbeat region, then a byzantine heartbeat write is detected. When such a byzantine heartbeat write has been detected, the ATS primitive fails, and such a failure is important for byzantine fault tolerance.

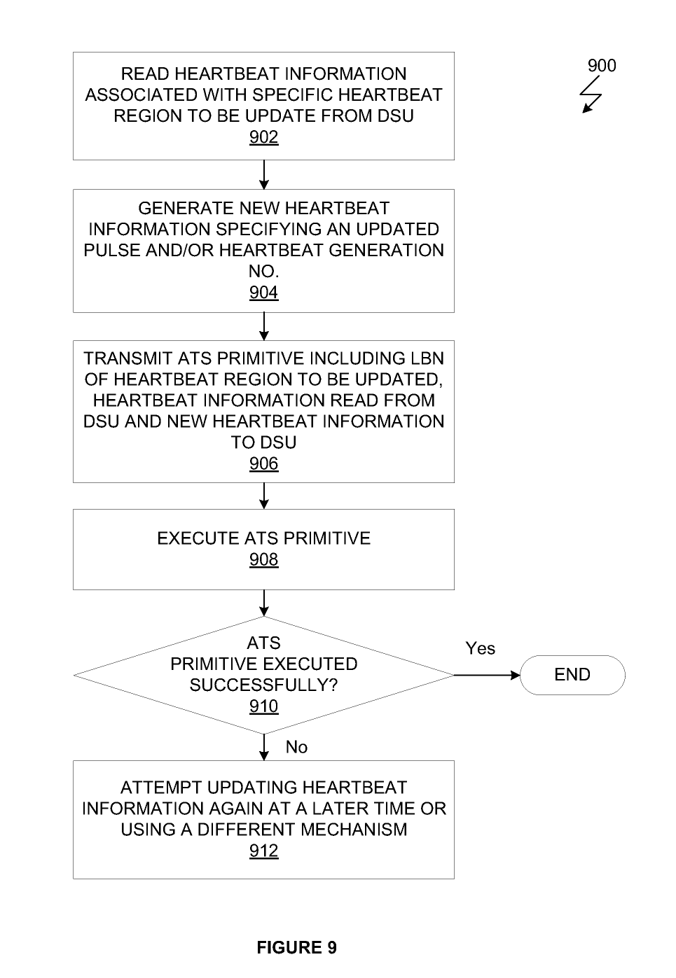

FIG. 9 is a flow diagram of method steps 900 for updating the heartbeat of a node, according to one or more embodiments of the present invention. For context and clarity and by way of example, method steps 900 are described herein using node 402(0) and heartbeat region 406(0) associated with node 402(0). It should be recognized that method steps 900 are applicable to other nodes and heartbeat regions.

Method 900 begins at step 902, where node 402(0) reads the heartbeat information stored within heartbeat region 406(0) associated with node 402(0) (referred to herein as the “old heartbeat information”). At step 904, node 402(0) generates new heartbeat information that specifies an updated pulse field 510, an updated heartbeat state 506 and/or and updated heartbeat generation number 508. At step 906, node 402(0) transmits an ATS primitive that includes a logical block number identifying the location of heartbeat region 406(0) in DSU 120, the old heartbeat information, and the new heartbeat information generated at step 904 to DSU 120.

At step 908, storage system manager 130 executes the ATS primitive received from node 402(0). When an ATS primitive is executed, storage system manager 130 first locates heartbeat region 406(0) based on the logical block number included in the ATS primitive. Storage system manager 130 then compares the old heartbeat information included in the ATS primitive with the heartbeat information stored in heartbeat region 406(0). If the old heartbeat information and the heartbeat information stored in heartbeat region 406(0) match, then storage system manager 130 replaces the heartbeat information stored in heartbeat region 406(0) with the new heartbeat information included in the ATS primitive. This results in the successful execution of the ATS primitive and consequently a successful updating of the heartbeat for node 402(0). However, if the old heartbeat information and the heartbeat information stored in heartbeat region 406(0) do not match, for example, when a byzantine heartbeat write has occurred, then the new heartbeat information is not stored in heartbeat region 406(0) and the execution of the ATS primitive fails.

In one embodiment, in the case of an ATS primitive execution failure, storage system manager 130 transmits an error code to node 402(0) indicating the execution failure.

At step 910, node 402(0) determines whether the ATS primitive executed successfully. If the ATS primitive executed successfully, then method 900 ends. If, however, the ATS primitive did not execute successfully, then method 900 proceeds to step 912. At step 912, node 402(0) attempts to update the heartbeat region 406(0) again at a later time or through a different technique known in the art.

Although the inventive concepts disclosed herein have been described with reference to specific implementations, many other variations are possible. For example, the inventive techniques and systems described herein may be used in both a hosted and a non-hosted virtualized computer system, regardless of the degree of virtualization, and in which the virtual machine(s) have any number of physical and/or logical virtualized processors. In addition, the invention may also be implemented directly in a computer's primary operating system, both where the operating system is designed to support virtual machines and where it is not. Moreover, the invention may even be implemented wholly or partially in hardware, for example in processor architectures intended to provide hardware support for virtual machines. Further, the inventive system may be implemented with the substitution of different data structures and data types, and resource reservation technologies other than the SCSI protocol. Also, numerous programming techniques utilizing various data structures and memory configurations may be utilized to achieve the results of the inventive system described herein. For example, the tables, record structures and objects may all be implemented in different configurations, redundant, distributed, etc., while still achieving the same results.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments, may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s).

What is claimed is:

1. A method of managing accesses to a resource of a shared file system that is stored in a data storage unit (DSU), comprising:
reading a lock associated with the resource to obtain a current state of the lock;
determining that the lock is available based on the current state;
transmitting a request to the DSU to perform an atomic update to the lock comprising a first operation to confirm that the current state of the lock has not changed since the reading and a second operation to acquire the lock, wherein no other operation can be performed on the lock between the first operation and second operation; and
acquiring access to the resource upon receiving confirmation of successful completion of the atomic update, whereby no exclusive reservation of the DSU is required to acquire the lock.

2. The method of claim 1, wherein the atomic update is a “compare and write” SCSI command.

3. The method of claim 1, further comprising receiving an indication that the atomic update has failed if an intervening operation changes the current state of the lock between the reading step and the transmitting step.

4. The method of claim 1, performed by a host computer system coupled to the DSU, wherein the resource is a virtual disk file corresponding to a virtual machine running on the host computer system.

5. The method of claim 1, wherein the lock comprises an owner ID field and a lease field specifying a period of time for possessing the lock.

6. The method of claim 5, wherein the lock is determined to be available if there is no valid owner ID value in the owner ID field.

7. The method of claim 5, wherein the lock is determined to be available if the period of time in the lease field has expired.

8. The method of claim 5, wherein the lock further comprises liveness information indicating whether a host computer system possessing the lock is currently in communication with the DSU.

9. A non-transitory computer-readable storage medium including instructions for managing accesses to a resource of a shared file system that is stored in a data storage unit (DSU), that when executed by a computer processor, perform the steps of:
reading a lock associated with the resource to obtain a current state of the lock;
determining that the lock is available based on the current state;
transmitting a request to the DSU to perform an atomic update to the lock comprising a first operation to confirm that the current state of the lock has not changed since the reading and a second operation to acquire the lock, wherein no other operation can be performed on the lock between the first operation and second operation; and
acquiring access to the resource upon receiving confirmation of successful completion of the atomic update, whereby no exclusive reservation of the DSU is required to acquire the lock.

10. The non-transitory computer-readable storage medium of claim 9, wherein the atomic update is a “compare and write” SCSI command.

11. The non-transitory computer-readable storage medium of claim 9, wherein the instructions further comprise receiving an indication that the atomic update has failed if an intervening operation changes the current state of the lock between the reading step and the transmitting step.

12. The non-transitory computer-readable storage medium of claim 9, wherein the instructions are executed by a host computer system coupled to the DSU and wherein the resource is a virtual disk file corresponding to a virtual machine running on the host computer system.

13. The non-transitory computer-readable storage medium, wherein the lock comprises an owner ID field and a lease field specifying a period of time for possessing the lock.

14. A method of updating a heartbeat region associated with a node and stored in a data storage unit (DSU), comprising:
identifying a heartbeat region associated with a node, wherein the heartbeat region stores liveness information associated with the node;
generating updated liveness information associated with the node; and
performing an atomic update operation on the heartbeat region to store the updated liveness information in the heartbeat region, wherein at least one other resource of the shared file system is accessible while the atomic update operation is being performed.

15. The method of claim 14, wherein the atomic update operation is an atomic test and set (ATS) operation.

16. The method of claim 15, wherein the heartbeat region includes a logical block number (LBN) of the DSU at which the heartbeat region is located, and the ATS operation is performed using the LBN.

17. The method of claim 16, further comprising the step of reading the contents of the heartbeat region through a shared file system, wherein the ATS operation includes comparing the contents of the heartbeat region as read through the shared file system and the contents of the heartbeat region stored at the LBN.

18. The method of claim 17, wherein the ATS operation fails when the contents of the heartbeat region as read through the shared file system do not match the contents of the heartbeat region stored at the LBN.

19. The method of claim 14, wherein the updated liveness information includes an updated pulse that indicates that the node is alive.

20. The method of claim 14, wherein the updated liveness information includes an updated heartbeat generation number that is incremented when the heartbeat region is allocated to the node.
